(19) United States
(12) Patent Application Publication
(10) Pub. No.: US 2017/0038340 A1
(43) Pub. Date: Feb. 9, 2017

(54) DEVICE FOR INSPECTING A STRUCTURE

(71) Applicant: A3 MONITORING LTD, London (GB)

(72) Inventors: Andrea GALVAGNI, London (GB); Alessandro DEMMA, London (GB)

(21) Appl. No.: 15/302,520

(22) PCT Filed: Apr. 7, 2015
(86) PCT No.: PCT/GB2015/051065

§ 371 Date: Oct. 7, 2016

(30) Foreign Application Priority Data
Apr. 8, 2014 (GB) 1406337.4

(51) Int. Cl. G01N 29/04; G01N 29/32; G01N 29/22

(52) U.S. Cl. CPC G01N 29/043; G01N 29/223; G01N 29/32; G01N 2291/0422; G01N 2291/101; G01N 2291/0289

(57) ABSTRACT

There is presented a device for being secured to a structure. The device comprising a first portion comprising an element configured to impart mechanical waves to the structure upon application of a voltage and a second portion supporting the element and comprising a body. The body may be elastomeric, flexible, or both. The first and second portions are configured such that the element reacts against the second portion to generate mechanical waves at least partially within the structure. The body attenuates mechanical waves propagating from the first portion and away from the structure. A securing device for securing a mechanical wave generator to a structure and a system comprising the securing device are also presented.

The present invention relates to devices for inspecting structures, more particularly devices for testing structures for abnormalities using mechanical waves.

Inspection devices are known to use mechanical waves, also known as stress waves, to detect abnormalities in structures such as plates and pipes. Typically these devices transmit guided mechanical waves along the structure and detect reflections of the transmitted mechanical waves caused by the presence of abnormalities in the structure such as cracks or welds. These reflections may also be called ‘echoes’.

Different types of structures support different types or ‘modes’ of guided mechanical waves. Whether or not certain guided wave modes are caused to propagate along the structure is dependent upon whether or not the inspection device causes them to be excited.

Different structures may support multiple types of guided wave modes. The excitation of the modes is often facilitated by applying stress upon a surface of the structure using a transducer such as a piezoelectric element which is in contact with and moves laterally across a surface of the structure being inspected. Other transducer motions may also be utilised such as motions normal to the structure surface. The motions of the transducers may excite multiple guided wave modes.

Often when inspecting a structure, it is desirable to excite just one guided wave mode so that abnormalities in the structure can be easily distinguished from the returning echoes. To excite just one particular guided wave mode, multiple transducers are required to be positioned on the surface of the structure. These positions often follow specific patterns, and the activation of the transducers needs to be precisely synchronised.

Using guided waves to inspect a pipe allows the inspection of an entire volume of a section of pipe from a single axial location. The guided wave modes of pipes may be divided into three main groups: longitudinal, torsional and flexural. Such modes are commonly written as L(n,m), T(n,m) and F(n,m) respectively, where n is the order around the circumference and m is a counter to describe different types of motion through the pipe wall. A pipe supports a number of different modes of the same mode type, for example longitudinal modes L(0,1), L(0,2) and torsional modes T(0,1), T(0,2). Different modes possess different propagation characteristics including whether or not they are non-axisymmetric or axisymmetric and whether or not they are dispersive.

Longitudinal and torsional modes are axisymmetric whilst flexural modes are non-axisymmetric. Apart from the T(0,1) mode, all other guided wave modes that can propagate in a pipe are dispersive because their phase and group velocities are a function of frequency. Dispersion causes an excited wave packet to stretch as it propagates since different frequency components travel at different velocities. This in turn causes the peak amplitude of the wave packet to decrease quickly until it becomes close to the amplitude of the background noise, thus limiting the practical propagation range. The T(0,1) mode is therefore a suitable mode to excite for pipe inspection due to its flat dispersion relationship and its ability to be easily excited.

Torsional modes in a pipe may be excited by imparting shear vibrations, or waves, to the outer surface of the pipe in a circumferential direction. Shear polarised piezoelectric elements may be used to excite and detect such torsional modes by providing electrical connectivity to two opposing surfaces of the element. When an electrical potential difference is applied across the two surfaces, the piezoelectric element converts the electrical potential into mechanical stress. Conversely the same piezoelectric element may convert mechanical stress, i.e. compression or shear or even a combination of the two depending on the polarisation of the particular element, into a difference of electric potential, i.e. voltage, across two of its surfaces. A backing block is typically attached to the opposite side of the element to the structure to provide a mass for the piezoelectric element to react against to ensure that the surface of the piezoelectric element adjacent to the structure moves relative to the structure when a voltage signal is applied. Example of backing blocks are described in U.S. Pat. No. 6,148,672 which uses either a rigid steel block or a backing chamber filled with tungsten loaded epoxy resin, which is described in U.S. Pat. No. 6,148,672 as a ‘lossy material’.

Piezoelectric elements are therefore suitable for the transduction of guided waves in solid components as a single piezoelectric element could be utilised both to excite guided waves by applying a voltage across the element, and/or to receive echoes by detecting changes in the voltage across the element.

Devices are known to excite the T(0,1) mode in pipes. Such devices utilise two or more adjacent rings of closely spaced piezoelectric transducers, each ring being circumferentially mounted upon a circumferential metal backing block that clamps the transducers to the pipe. One issue that piezoelectric transducers have when exciting the torsional T(0,1) mode is that the shear stress waves generated by the piezoelectric transducers may not be confined to within the pipe and may give rise to cross talk, particular when the transducers are closely spaced.

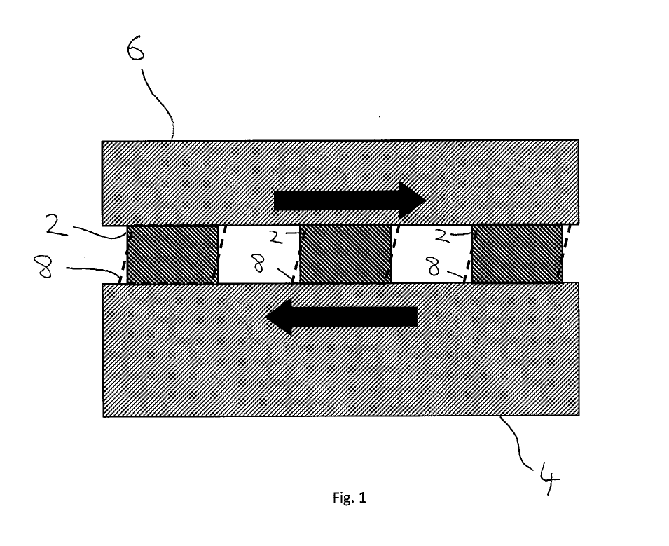

Cross-talk increases the background noise level and arises from stress waves generated by or passing through one transducer and reaching another transducer located nearby. For example, FIG. 1 illustrates a series of three closely spaced piezoelectric transducers 2 in contact with a structure under test 4 and a rigid backing block made of metal 6. As the piezoelectric transducers are made to shear through the application of a voltage signal (electrical connections not shown), the transducer distort 8 causing (intended) stress waves 10 to propagate in the structure 4 as well as unwanted stress waves 12 propagating in the metal backing block 6. The stress waves propagating in the metal backing block give rise to cross talk. Cross talk between neighbouring piezoelectric transducers is particularly a problem when the generation of the mechanical waves is accomplished by time sequential activation of the transducers. This is particularly the case when the determination of the location of structure abnormalities is dependent upon the position of the detecting transducer.

Echoes detected from reflections of the guided mechanical waves may be of differing amplitude dependent upon the distance that the mechanical wave and resulting echo have travelled to and from the device. The amplitude of the echo may also differ due to the type of reflecting discontinuity. Therefore, some detected echoes may be larger in amplitude compared to others. In order to detect as many types and locations of structure discontinuities as possible, it is desirable to have a low background noise level at the device transmitting and detecting the guided stress waves. Reducing crosstalk is therefore desirable to help clearly identify mechanical wave reflections over long lengths of the structure.

Rigid mechanical frames that hold the piezoelectric transducers in place and press them against the surface of the solid component have been employed to try to reduce cross talk. However, in practice, the mechanical frames need to be different from application to application, for example, for pipes of different diameter. The transducer acts as a spring between the backing block and the structure under test. For a given transducer and backing block, this system has a resonant frequency that is essentially fixed since the structure under test can be viewed as an immovable half-space. Depending on the structure and inspection requirements, waves are desirably transduced at frequencies close to this resonance. Different transducer assemblies with different backing blocks (hence different resonant frequencies) are therefore often required for different applications.

Guided waves propagated or received close to the resonant frequency of the transducer-backing block assembly system are very noisy and unreliable because of sudden phase shifts that can occur at frequency ranges in the vicinity of the resonant frequency. Therefore in practice the transducer assemblies must vary from application to application and a single rigid testing assembly suitable for one structure may not be suitable for another structure.

According to a first aspect of the present invention there is provided a device for being secured to a structure, the device comprising: a first portion comprising an element configured to impart mechanical waves to the structure upon application of a voltage, and, a flexible second portion supporting the element and comprising a body; wherein the first and second portions are configured such that: the element reacts against the second portion to generate mechanical waves at least partially within the structure; the body attenuates mechanical waves propagating from the first portion and away from the structure.

The first aspect may be modified in any suitable way as disclosed herein including but not limited to any one or more of the following.

The device may be configured such that the body of the second portion comprises an elastomeric material.

According to a second aspect of the present invention there is provided device for being secured to a structure, the device comprising: a first portion comprising an element configured to impart mechanical waves to the structure upon application of a voltage, and, a second portion supporting the element and comprising a body comprising elastomeric material; wherein the first and second portions are configured such that: the element reacts against the second portion to generate mechanical waves at least partially within the structure; the body attenuates mechanical waves propagating from the first portion and away from the structure.

The second aspect may be modified in any suitable way as disclosed herein including but not limited to any one or more of the following.

The device may be configured such that the body of the second portion comprises a flexible material.

The first and second aspects may be modified in any suitable way as disclosed herein including but not limited to any one or more of the following.

The device may be configured to be secured to the structure by a securing device.

The device may be configured such that the second portion is configured to electrically isolate the element from the securing device.

The device may be configured such that the body has a Mooney viscosity of at least 50.

The device may be configured such the body has a Shore A hardness of 50 or higher.

The device may be configured such that the element is a piezoelectric transducer.

The device may be configured such that the element configured to impart mechanical waves comprises a shear polarised piezoelectric transducer.

The device may be configured such that the device is configured to be able to detect and generate mechanical waves in the structure.

The device may be configured such that the device is configured to be able to detect and generate shear waves within the structure.

The device may be configured such that the second portion is in contact with the element.

The device may comprise one or more layers configured to provide electrical contact to the element.

The device may be configured such that the at least one of the said layers is interposed between the element and the structure.

The device may be configured such that at least one of the said layers is interposed between the element and the body.

The device may be configured such that any one or more of the said layers comprises a flexible PCB.

The device may be configured such that the body of the second portion is substantially solid throughout.

According to a third aspect of the present invention there is provided a securing device for securing a mechanical wave generator to a structure, the mechanical wave generator arranged when secured to the structure to generate mechanical waves at least partially within the structure, the securing device comprising: a first portion comprising a first material; a second portion comprising a second material different to the first material and configured to attenuate mechanical waves propagating away from the structure towards the first portion.

The third aspect may be modified in any suitable way as disclosed herein including but not limited to any one or more of the following.

The securing device may be configured such that the first material comprises a rigid material at least partially surrounding the second portion.

The securing device may be configured such that the second material comprises an elastomeric material.

The securing device may be configured such that the second material has a Mooney viscosity of at least 50.

The securing device may be configured such that the second material has a Shore A hardness of 50 or higher.

According to a fourth aspect of the present invention there is provided a system comprising the securing device as described in the third aspect (and optionally any addition of modification to the third aspect) and a mechanical wave generator.

The fourth aspect may be modified in any suitable way as disclosed herein including but not limited to any one or more of the following.

The system may be configured such that the mechanical wave generator comprises one or more a transducers for generating mechanical waves at least partially within the structure.

The system may be configured such that the second material is configured, when the mechanical wave generator is secured to the structure with the securing device, to provide a supporting body against which the transducer may react against to generate mechanical waves at least partially within the structure.

According to a fifth aspect of the present invention there is provided a device for being secured to a structure and comprising: a first portion comprising an element configured to impart mechanical waves to the structure upon application of a voltage; and, a second portion comprising a flexible layer configured to wrap the device at least partially around the structure.

The fifth aspect may be modified in any suitable way as disclosed herein including but not limited to any one or more of the following.

The device may comprise a plurality of the said elements arranged in a pattern along the second portion.

The device may be configured such that the pattern of elements is a series of elements spaced apart along the second portion.

The device may be configured such that the flexible layer comprises an elastomeric material.

The device may be configured such that the flexible layer has a Mooney viscosity of at least 50.

The device may be configured such that the flexible layer has a Shore A hardness of 50 or higher.

The device of any of the first, second and fifth aspects (any optionally any of their optional additions or modifications) may be configured as a sheet. Preferably the second portion is configured to be sheet-like. The sheet may be an elongate strip having separate first and second terminating portions at the elongate ends of the strip.

Embodiments of the present invention will now be described in detail with reference to the accompanying drawings, in which:

FIG. 1 shows a cross section of a device comprising three transducers mounted upon a rigid backing material and in contact with a structure to be inspected;

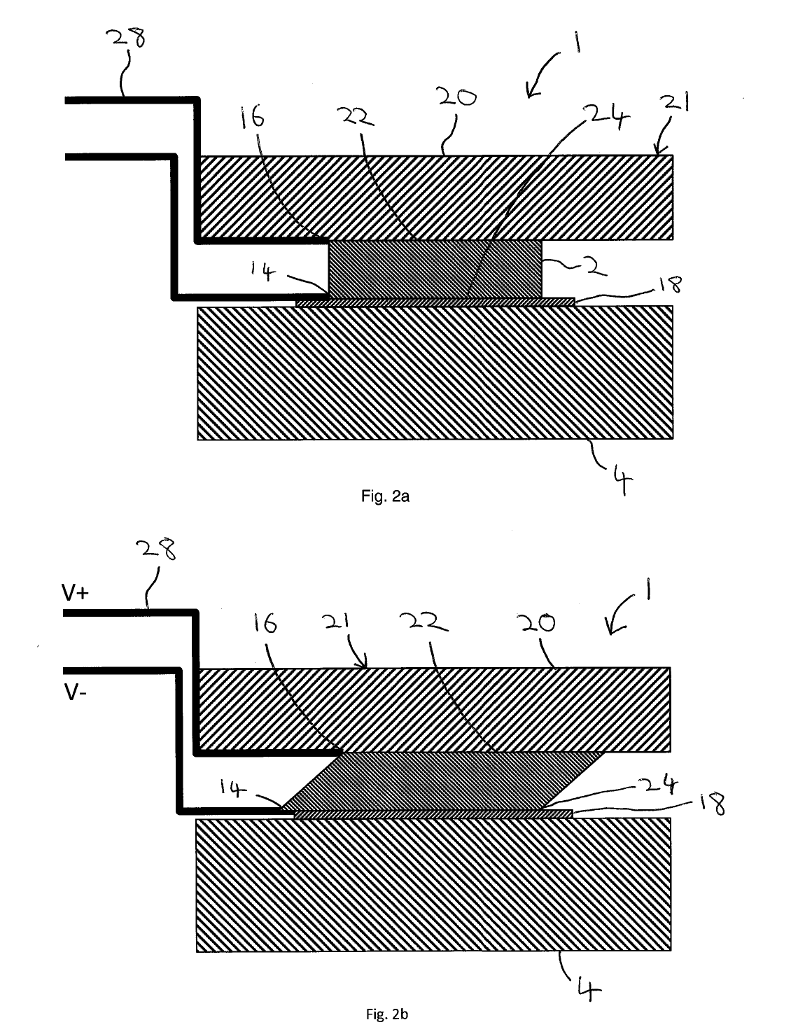

FIG. 2a shows a cross section of a device in contact with a structure, the device comprising a transducer, an intermediate layer and electrical connections;

FIG. 2b shows the same device of FIG. 2a wherein a voltage is applied across the transducer causing it to distort and apply shear stress to the structure;

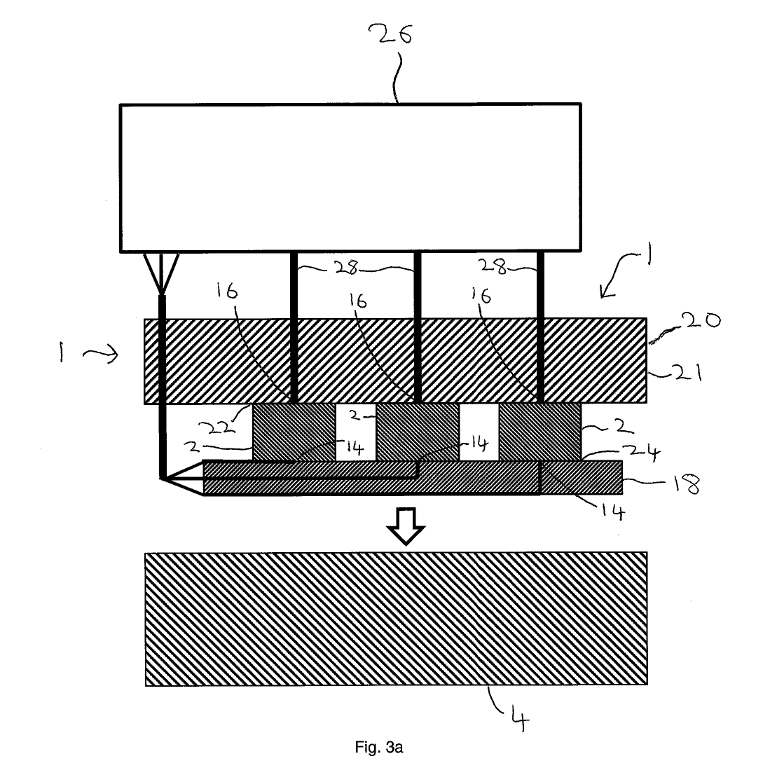

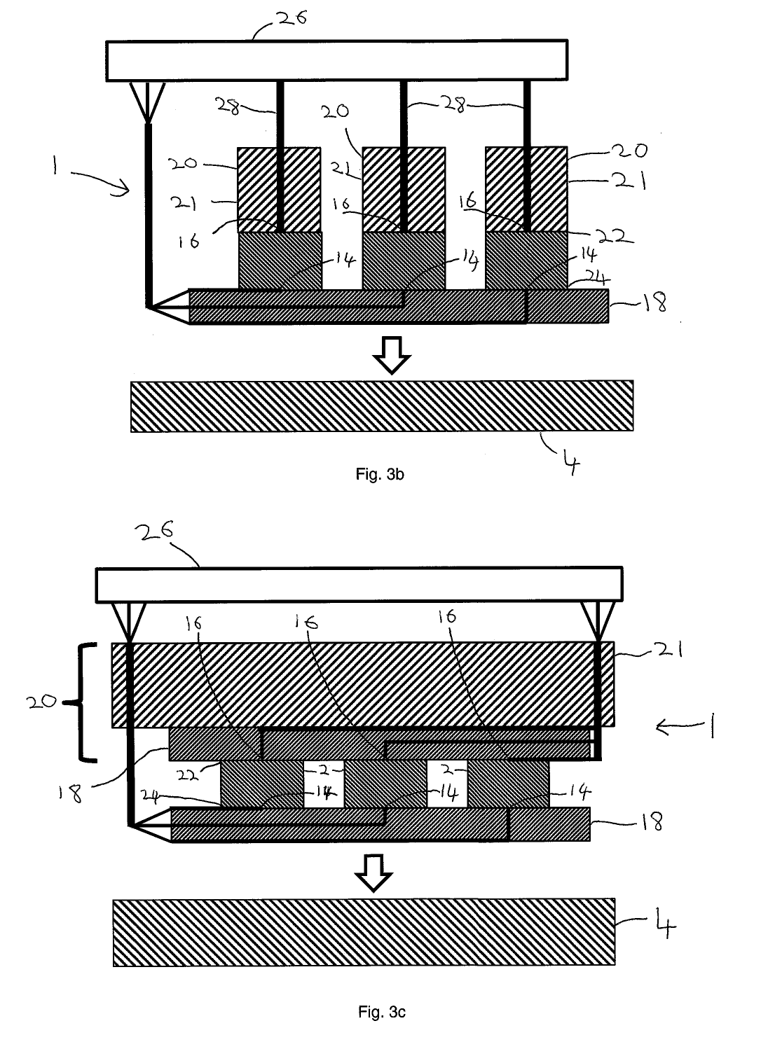

FIGS. 3a, 3b and 3c show devices comprising three transducers supported by backing portions and attached to a common Printed Circuit Board (PCB);

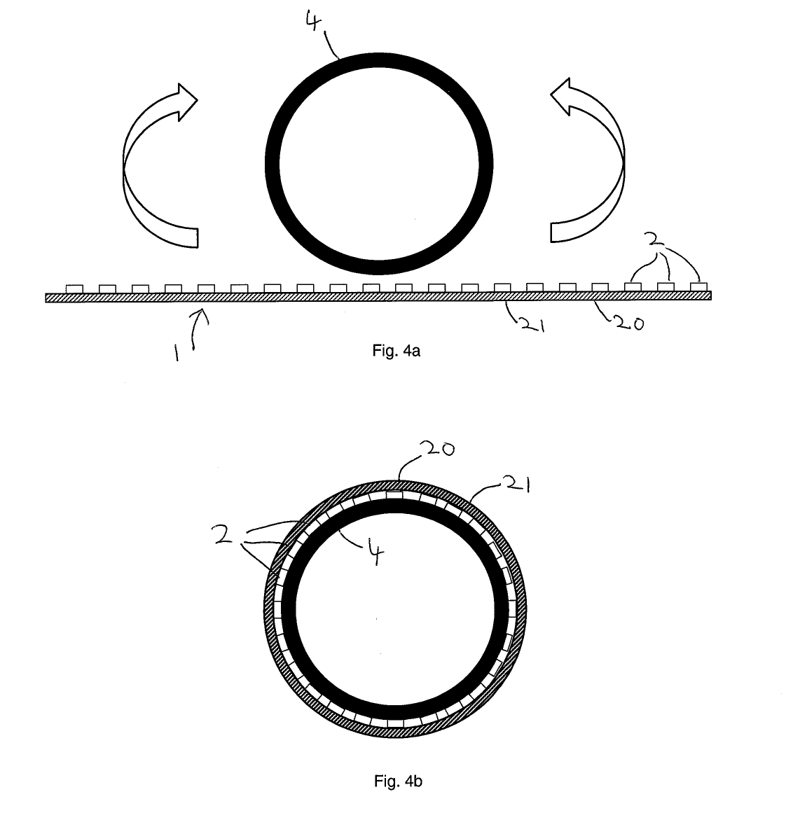

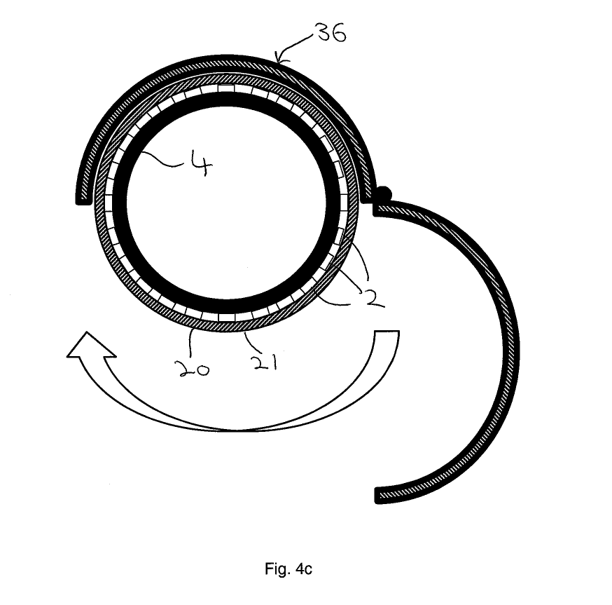

FIGS. 4a-c shows a device with a backing portion and a plurality of transducers being wrapped around a pipe and secured by a securing device;

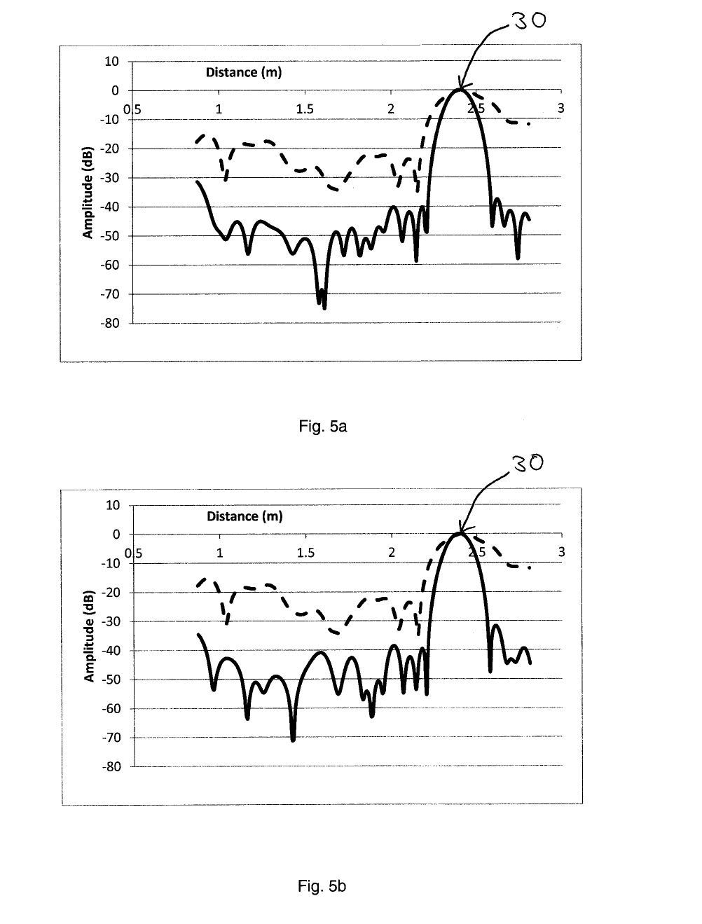

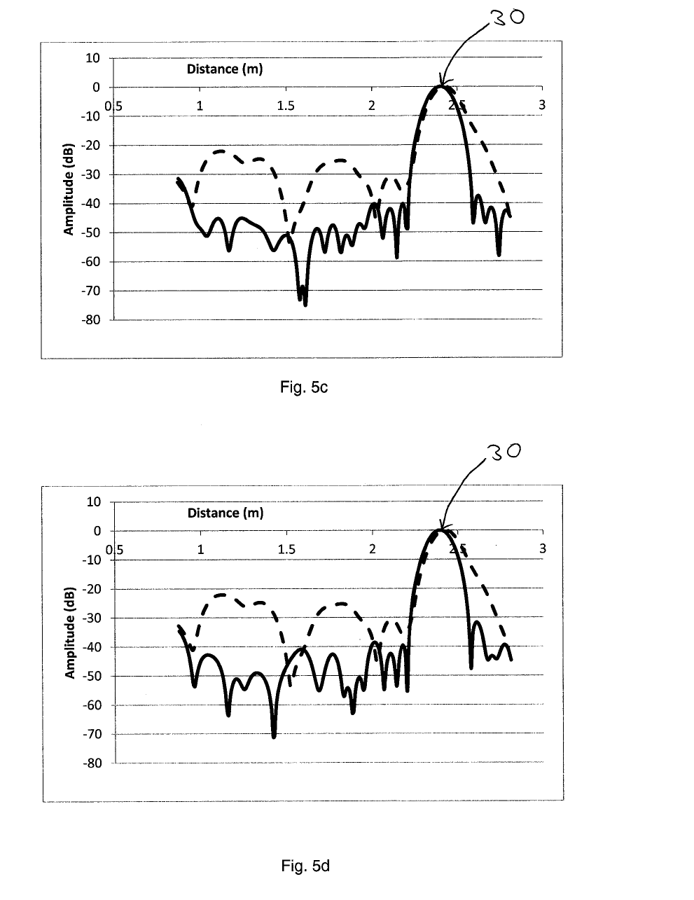

FIGS. 5a-5d show graphs of results of detected reflections from prior art devices with a metal backing and those of a device described herein;

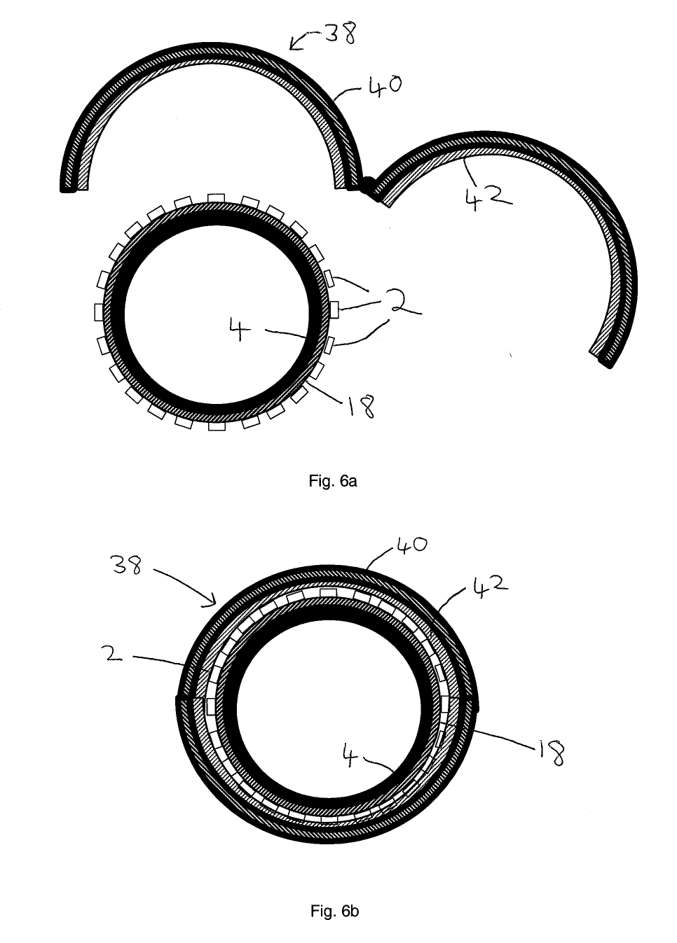

FIG. 6a shows a securing device for securing a device to a structure, the securing device comprising an inner layer of absorbing material and a rigid outer layer;

FIG. 6b shows the securing device of FIG. 6a securing, to a pipe, a device comprising a series of transducers mounted upon a flexible PCB.

Devices 1 are presented for inspecting structures 4 using mechanical waves. The devices 1 described herein may generate and detect mechanical waves in a structure 4. The structure 4 that the devices 1 inspect may in principle be any structure 4, but are preferably elongate solid structures such as, but not limited to, plates and pipes or any structure 4 with flat or curved surfaces that the device 1 can contact. Solid structures 4 are typically made from a metal, metallic composite, solid plastic composite or a solid fibre reinforced composite.

Securing devices 38 are also presented for securing an inspection device to a structure under test 4.

The devices 1 and securing devices 38 described herein may be configured to be used for inspecting pipes of any diameter, including but not limited to, pipes with diameters varying between 50 mm-1500 mm.

The devices 1 described herein may in principle generate mechanical waves at any suitable frequency to inspect the structure 4. Preferably the devices generate mechanical waves with frequencies less than 1 MHz, more preferably less than 500 kHz, even more preferably less than 50 kHz. Preferably the devices 1 generate mechanical waves at frequencies between 1 kHz-500 kHz, more preferably between 10-50 kHz.

### EXAMPLES

There now follows some examples of devices 1 wherein features, configurations and principles of each example may be modified by using any other suitable feature, configuration and principle described herein.

In one example there is provided a device 1 for being secured to a structure 4. A first portion of the device comprises an element 2 (commonly referred to throughout as a ‘transducer’) configured to impart mechanical waves to the structure 4 upon application of a voltage. A second portion of the device, also known as a backing portion 20 comprises a flexible layer configured to wrap the device 1 at least partially around the structure 4.

FIGS. 2a and 2b show an example of a shear polarised piezoelectric ceramic element 2 being activated to apply shear stresses upon a section of a structure 4 such as, but not limited to, a pipe. FIG. 2a shows the piezoelectric element 2 having electrical contacts 14, 16 and an intermediate portion 18 between the piezoelectric element 2 and the structure 4.

The intermediate layers 18 in the examples of all the devices 1 described herein preferably have thicknesses that are small enough to not efficiently transmit mechanical waves along the plane of the layer at the operating frequency of the device (i.e. the frequency of stress waves generated by the one or more elements 2). At such thicknesses, the mechnical wave energy carried by the layer is negligible and is quickly absorbed by material attenuation. Therefore an intermediate layer 18 (with such a thickness) spanning between adjacent transducers 2 does not contribute significant cross talk between adjacent transducers 2. Any stress waves propagating in the plane of the layer 18 are quickly leaked into surrounding layers such as a body 21, which in turn absorbs such stress waves.

One electrical connection 14 (referred to herein as the bottom contact) is in physical contact with the shear surface 24 nearest to the structure 4, whilst the other electrical connection 16 (referred to herein as the top contact) is in physical contact with the shear surface 22 furthest from the structure 4. Any of the electrical connections 14, 16 may be one or more wires, an electrical contact on a PCB or any other suitable connection configured to electrically connect a surface 22, 24 of the transducer 2 to an electrical power source 26.

In principle, the bottom electrical contact 14 may not be required for the devices 1 described herein. In such circumstances, the structure under test 4 may be used as an electrical contact for the transducer 2. Furthermore, in principle, the top electrical contact (for example an electrical wire) may not be required for the devices 1 described herein. In such a circumstance, electrical connectivity may be made with the top shear surface 22 by doping all or a portion of a material contacting the shear surface 22 so that the said contact material electrically conducts.

The intermediate portion 18 may be a protective layer that protects the transducer 2 and the bottom electrode 18 from contact with rough surfaces of the structure 4. This layer may comprise a PCB, wherein the PCB comprises the bottom electrode 14. For some devices 1 described herein, the intermediate portion 18 may not be required.

The top surface 22 of the transducer 2 is in contact with a backing portion 20 that supports the transducer 2. The backing portion 20 comprises a body 21 that attenuates stress waves propagating away from the transducer 2 and structure under test 4. The device 1 is configured such that the transducer 2 can react against the second portion (i.e. the backing portion 21, which in FIGS. 2a and 2b has a backing body 21) when applying shear stress to the structure 4. By the term “react against”, it is intended to mean that when the transducer 2 is held or pressed against the structure under test 4, an applied electrical signal will cause the bottom shear surface to move relative to the structure 4 and transduce stress waves to the structure 4. The transducer 2 may react against the backing portion body 21, or a further part of the backing portion 20 between the body 21 and the transducer, such as an intermediate layer (for example a flexible PCB comprising an electrical connection 16 to the top shear surface 22).

The backing portion 20 and transducer 2 may therefore be described as a system or device wherein the transducer 2 is at least a part of a first portion and the backing portion 20 is the second portion wherein the first and second portions are configured such that the transducer 2 reacts against the second portion 20 to generate mechanical waves at least partially within the structure 4. The backing body 21 is preferably a flexible material and/or an elastomeric material that attenuates mechanical waves propagating away from the transducer 2 and the structure under test 4. By having the backing portion 20 attenuating/absorbing stress waves generated by the transducers 2, the crosstalk between the transducers reduces. This is particularly advantageous when the device 1 is clamped to the structure using a securing device 36 that can propagate stress waves.

The term ‘flexible’ is intended to mean that the layer or feature can bend easily without breaking, for example around a pipe.

A flexible backing portion 20 or a flexible backing portion body 21 allows the device 1 to be made as a sheet. The sheet may be a long elongate strip that can optionally be cut to the size of the structure 4 required and wrap around at least part of the structure under test 4, for example wrapping around the whole circumference of a pipe as shown in FIGS. 4a and 4b. Alternatively, the sheet can be formed in situ on the transducers 2. The elongate strip preferably has separate first and second terminating portions at the elongate ends of the strip that may be joined or overlapped when wrapping and affixing the device to the structure under test 4.

FIG. 3a shows a similar device as shown in FIGS. 2a and 2b. In this example the device comprises a plurality of transducers 2 (three transducers in this example). The transducers 2 are piezoelectric elements directly mounted upon the backing body 21 using an adhesive (although any means of fixation or holding the transducers in position against the backing body 21 may be used). In this example the backing portion 20 only contains the backing body 21. The bottom surfaces 24 of the piezoelectric elements 2 are affixed to a common PCB intermediate layer 18. The PCB 18 comprises electrical tracks that end in electrical contact pads 14 on the top surface of the PCB 18 adjacent the piezoelectric elements 2.

The top surface 22 of each of the piezoelectric elements 2 is electrically connected to a wire 28 that extends through the backing portion 20 and electrically connects to an electrical power source 26 such as a voltage signal generator. In principle the wires connecting any of the surfaces of the transducers 2 to a power source 26 may be arranged to run through, partially within or around the backing portion 20. The PCB 18 also electrically connects to the same power source 26. The power source 26 is used to drive the device 1 by providing one or more voltage signals to the piezoelectric elements 2. The electrical connections may also be used to monitor voltages generated by the piezoelectric elements 2 in response to detecting echoes.

FIG. 3b shows a further example of a device 1 similar to FIG. 3a wherein the device 1 comprises multiple backing portions 20, wherein in each backing portion 20 comprises a backing body 21 affixed to the top shear surface 22 of a separate transducer 2.

FIG. 3c shows a further example of a device 1 similar to FIG. 3a wherein the backing portion 20 comprises a body 21 for absorbing mechanical stress waves and an intermediate layer 18 in contact with the transducers 2. The intermediate layer in this example is a PCB, preferably a flexible PCB, containing electrical tracks contacting the top shear surface 22 of the transducers 2. The body 21 of the backing portion 20 contacts the intermediate layer 18 such that the intermediate layer 18 is sandwiched between the body 21 and the transducers 2.

In all of the above examples shown in FIGS. 3a, 3b and 3dc, the body 21 is disposed between the transducers and a securing device 36 (not shown) to intercept and absorb the stress waves propagating towards the securing device.

FIG. 4a shows a cross section of a pipe 4 and a device 1 comprising a backing portion 20 and a plurality of piezoelectric elements 2 mounted onto the backing portion 20 (electrical contacts to the piezoelectric elements are not shown). In this example, the backing portion 20 comprises a flexible strip body 21 that allows the device to wrap around a pipe structure 4 so that each of the piezoelectric elements contacts a portion of the outer surface of the pipe 4 as shown in FIG. 4b. In this example there is no PCB interfacing between the transducer elements 2 and the outer surface of the pipe 4. However in principle a flexible PCB could be provided to the device 1 to provide this feature. FIG. 4c shows the same device of FIGS. 4a and 4b whereby a securing device 36 is being employed to circumferentially surround the device 1 and clamp it to the outer surface of the pipe 4 to ensure that the elements 2 are pushed into physical contact with the pipe 4.

### Results

Two devices 1 were manufactured in a manner similar to that shown in FIG. 4a and described above. Each device 1 was, in turn, wrapped around a common metal pipe (structure under test 4) in a similar manner to that shown in FIG. 4b and secured to the pipe 4 with a metal ring clamp 36.

The first device 1 comprised a backing portion 20 with a body 21 made from an elongated rectangular strip of a fluoroelastomer, Viton A700™ upon which was mounted a plurality of shear polarised piezoelectric transducers 2. The transducers 2 were arranged into two parallel lines, with equal spacing between neighbouring transducers 2 on each line. The transducers 2 were held firmly in place against the backing body 21 by friction caused by the pressure of the outer metal clamp.

A flexible PCB layer 18 made from polyimide with copper electrical contact traces was mounted to the bottom shear surface 24 of the piezoelectric elements 2. The piezoelectric elements 2 were affixed to the contact traces using a silver loaded epoxy adhesive. The PCB layer 18 comprised electrical connections to each of the piezoelectric elements 2 and an electrical connection to a voltage signal generator 26. A wire 28 was attached to the top shear surface 22 of each piezoelectric element 2, wherein each wire was also connected to the signal generator 26.

The second device 1 was identical to the first device 1 except that the body 21 was made from a silicone rubber, Sylgard™ 3-6605.

The devices 1 were driven using a signal generator to excite the T(0,1) mode in the pipe and detect the resulting echoes to inspect the pipe for discontinuities. The results of the tests are shown in FIGS. 5a-5d. The solid traces in each graph represent the results from the devices 1 as described above with the Viton™ A700 or Sylgard™ 3-6605 backing portions 20. The dashed lines represent the results taken from devices with either a steel clamping backing portion or a steel and polyurethane clamping backing portion instead of the polymeric material 21. The steel and polyurethane device was configured such that the steel directly contacted the transducers whilst the polyurethane was a tape located on the opposite side of the steel clamp to the transducers. The tape was introduced to try and improve cross talk damping. Each of the FIGS. 5a-5d show reflected wave amplitude vs distance of the reflection down the pipe from the devices tested.

FIG. 5a compares the results of the Viton™ A700 device 1 and the device with a steel backing portion. The solid line trace is the result of the Viton™ A700 device 1, whilst the broken line-trace is of the device with a steel backing portion.

FIG. 5b shows the results of the Sylgard™ 3-6605 device 1 and the device with a steel backing portion. The solid line trace is the result of the Sylgard™ 3-6605 device 1, whilst the broken line-trace is of the device with a steel backing portion.

FIG. 5c shows the results of the Viton™ A700 device 1 and the device with a steel and polyurethane backing portion. The solid line trace is the result of the Viton™ A700 device 1, whilst the broken line-trace is of the device with a steel and polyurethane backing portion.

FIG. 5d shows the results of the Sylgard™ 3-6605 device 1 and the device with a steel and polyurethane backing portion. The solid line trace is the result of the Sylgard™ 3-6605 device 1, whilst the broken line-trace is of the device with a steel and polyurethane backing portion.

All of the FIGS. 5a-5d show a clear reflection peak 30 for the ‘Viton™, Sylgard™ and steel backed devices corresponding to a detected discontinuity in the pipe 4. The ‘steel’ traces, both for the bare and polyurethane covered steel band generally show a much higher level of background noise compared to the ‘Viton™ and Sylgard™ traces. This shows that the devices 1 formed with the Viton™ A700 and Sylgard™ 3-6605 backing bodies 21 successfully reduce cross talk by absorbing stress waves emanating away from the pipe 4 and transducers 2.

The devices 1 described herein may be formed according to any of the features and principles described herein, including the example devices 1 described above. In particular, devices 1 may be configured according to, but not limited to any of the variations now described.

### Transducer Elements

The devices 1 use one or more elements 2 configured to impart mechanical waves to the structure 4 upon application of an electrical potential difference (voltage). These elements 2 (or transducers) are preferably polarised (for example a piezoelectric element) and in electrical contact with one or more electrical connections 14, 16 configured to provide the required voltage across the transducer 2. The transducers 2 may be shear polarised such that upon application of a voltage between two opposing surfaces 22, 24 (referred to as shear surfaces), the transducer 2 distorts 8 such that the opposing shear surfaces 22, 24 move laterally away from each other along parallel planes. In such a configuration, the waves generated may be shear waves, such as torsional waves in a pipe structure 4.

Such elements 2 may be piezoelectric crystals, also known as piezoelectric ceramic crystals or piezoelectric transducers. An example of a suitable type of piezoelectric ceramic crystal for use with the devices 1 presented herein is PZT-5H, however any piezoelectric crystal may be used in principle.

The transducers 2 may be affixed to adjacent portions of the device 1 such as the backing body 21 or an intermediate layer 18 using any suitable means, such as (but not limited to) an adhesive. When fixing to an intermediate layer 18 with electrical contact traces such as a PCB, the transducer elements 2 are preferably fixed using an electrically conducting adhesive such as a silver loaded epoxy.

### Backing Portion

The backing portion 20 may be formed from any one or more portions, for example one or more bodies affixed together to form the backing portion 20. The backing portion 20 or backing body 21 may in principle be any suitable thickness so long as the element 2 can react against it and it can attenuate stress waves. The backing portion 20, or any one or more of the bodies 21 of the backing portion 20, may be directly contacted to at least a portion of the top shear surface of the one or more transducers 2. The backing portion 20 may contact other parts of the transducers 2, for example one or more of the transducer sides extending between the top 22 and bottom 24 shear surfaces. In one example the transducers 2 may be partially embedded within the backing portion 20. The backing portion 20 or backing body 21 is preferably configured to electrically isolate the transducer 2 from an optional surrounding securing device 36.

The device 1 may be configured such that one or more thin layers of material (for example an adhesive material) are disposed at the interface between the backing portion 20 and the transducer 2. The optional one or more layers are preferably of negligible thickness, therefore are not solid bodies against which the transducer can react.

In one example, the backing portion/s 20 may comprise a first body supporting the transducers. The first body may be a body of any suitable material that the transducer can react against to transduce mechanical waves in the structure under test. In such a circumstance, the backing portion 20 comprises one or more further bodies 21 (for example, optionally contacting and residing between the first body and an outer securing device 36) that comprise a material that absorbs stress waves. Such a device 1 is exemplified in FIG. 3c wherein the first body is the intermediate layer 18 contacting the top shear surface 22 of the transducers whilst the second further body 21 is disposed on top of the first body. The further body 21 may be configured to adjoin the separate transducers 2 and backing first bodies into a single device 1 that allows the device 1 to be shaped to fit against a surface of at least a portion of the structure 4, for example a non-flat surface. Such a non-flat surface may be a pipe. In the example of FIG. 3c, the first body of the backing portion 20 may be a flexible intermediate layer 18 (as described herein), such as a PCB layer contacting and providing electrical connectivity to the transducers 2 on one side of the PCB whilst the second body 21 may border the other side of the PCB.

In another example, a device 1 may comprise a solid and rigid (non-flexible) first body (such as a rigid plastic material or a steel backing block) immediately supporting the transducers 2 (one for each transducer). Each of the rigid supporting first bodies may then be mounted upon a common second body 21 formed from an elongate strip of flexible material that absorbs stress waves so that any stress waves propagating in the device 1 between the transducers 2 gets absorbed. Such a device 1 may be used for surrounding the outer circumference of a pipe structure under test 4. There may in principle be any number of bodies between the transducer 2 and adjoining flexible layer 21. There may in principle be more than one flexible joining layer in the device. The transducers 2 and associated first body backing portions are preferably spaced apart from each other in series as described elsewhere in this application. The adjoining flexible second body 21 of this example may be comprised of any one or more of an elastomeric material and/or flexible materials of the absorbing backing bodies described in the following example.

In another example, the backing portion 20 may comprise a body 21 that supports the transducers 2, provides a surface for the transducers 2 to react against and is made from one or more flexible materials and/or one or more elastomeric materials, as shown in the device of FIG. 3a. Such materials may be electrically non-conductive. The material/s making up the backing body 21, together with its configuration (shape and location) with respect to the transducers 2 allows the backing portion 20 to attenuate mechanical waves propagating away from the transducer 2 and/or the structure 4. If a securing device 36 is used to secure the device 1 to the structure 4, then the backing portion 20, residing between the securing device 36 and the transducer/s 2 attenuates the waves propagating from the transducer 2 towards the securing device 36 and/or from the structure 4 towards the securing device 36. Preferably the backing body 21 is made from a flexible elastomeric material.

The material for producing the backing body 21 that absorbs the stress waves needs to be sufficiently soft enough to absorb stress waves so that the waves do not propagate into a securing device 36, which can then transmit the waves to another transducer 2 leading to unwanted cross talk. If the body 21 material is too rigid, the waves will be transmitted. Also, the material needs to be sufficiently rigid so that the transducer 2 has a firm enough body 21 to react against in order to impart stress waves into the structure 4.

The body 21 is preferably a solid body. The body 21 may be a substantially solid body, preferably being at least 80% solid, more preferably at least 90% solid, more preferably at least 95% solid.

In one preferred embodiment, the material for producing the backing body 21 comprises at least one elastomeric polymer. In preferred embodiments, the material comprises at least 50% by weight elastomeric polymer, more preferably 70%, yet more preferably 90% and most preferably the material consists of at least one elastomeric polymer.

The backing body 21 material preferably is one having a Mooney viscosity of at least 50, more preferably at least 60 and yet more preferably at least 70. The Mooney viscosity is preferably less than 200, and more preferably less than 180. The Mooney viscosity is measured using ASTM D1646 using conditions ML1+10, measured at 121° C.

It is further preferred that the backing body 21 material has a Shore A hardness of at least 50, preferably at least 55, even more preferably at least 60. The Shore A hardness is less than 90. Preferably the Shore A hardness is less than 85, most preferably less than 80. Preferred ranges of Shore A hardness may include, but not limited to, 50-90, more preferably 55-85, even more preferably 60-80. Shore A hardness is measured using ASTM D2240.

In a preferred embodiment, at least one elastomeric polymer in the backing body 21 material has a Mooney viscosity of at least 50, more preferably at least 60 and yet more preferably at least 70. The Mooney viscosity is preferably less than 200, and more preferably less than 180. The Mooney viscosity is measured using ASTM D1646 using conditions ML1+10, measured at 121° C. The elastomeric polymer is preferably one which forms at least 50% by weight of the backing material.

It is further preferred that the at least one elastomeric polymer in the backing body 21 material has a Shore A hardness of at least 50, preferably at least 60. The Shore A hardness is preferably less than 100. Shore A hardness is measured using ASTM D2240. The elastomeric polymer is preferably one which forms at least 50% by weight of the backing material.

Where the backing body 21 is formed of a blend of elastomeric polymers, the overall Mooney viscosity and Shore A hardness are particularly relevant. In this case, in one preferred embodiment, all of the elastomeric polymers have the above Mooney viscosity and Shore A hardness values.

In some cases, the backing body 21 is formed of different segments. It is preferred that each transducer is attached directly or indirectly to a segment which has one or more of the above Mooney viscosity and Shore A hardness values, so that the transducer reacts against this segment.

It is preferred that the elastomeric material is a solid material, that is it is not a foam. It is further preferred that the backing body 21 is formed of at least one layer of an elastomeric material and other optional materials such that the backing body 21 forms a solid block.

A number of suitable elastomeric materials are known to the skilled person. Suitable elastomeric materials include ethylene propylene rubbers, ethylene propylene diene rubbers, silicone rubbers, fluorosilicone rubbers, ethylene-vinyl acetate rubbers, fluoroelastomers and perfluoroelastomers. Preferred materials are fluorosilicone rubbers, perfluoroelastomers, fluoroelastomers and silicone rubbers.

Fluoroelastomers are commercially available for example from DuPont™ under the trade name Viton®, such as Viton® A700.

Fluoroelastomers are typically dipolymers or terpolymers of fluorine-containing unsaturated monomers, and in particular vinylidene fluoride, hexafluoropropylene, and tetrafluoroethylene. Suitable fluoroelastomers also include perfluoroelastomers. Suitable fluoroelastomers may have a specific gravity between 1.6 and 1.91, or between 1.7 and 1.8. Optionally the elastomer may comprise a polymer fluorine content between 60-71%, or 65-70%, or 65-68%, or any of 66%, 68.5%, 67%, 69.5%, 70%, 64%, 66.5%.

Particularly suitable fluoroelastomers are those having the above listed Mooney viscosity and/or Shore A hardness values. The skilled person will be aware of how to produce such fluoroelastomers.

Another particularly preferred group of materials is silicone rubber. Silicone rubbers are typically polydimethylsiloxanes or polydialkylsiloxanes. Suitable silicone rubbers are those available from Dow Corning®, and in particular silicone rubbers sold under the trade names Dow Corning® and XIAMETER®. A particularly preferred family of silicone rubbers are those sold under the brand name Sylgard®, including Sylgard® Q3-6605.

Particularly suitable silicone rubbers are those having the above listed Mooney viscosity and/or shore A hardness values. The skilled person will be aware of how to produce suitable silicone rubbers.

Preferably the backing body 21 material is non-conductive, i.e. not a ‘lossy’ material. The backing body 21 may, in principle, be any thickness. It is to be appreciated that the backing material needs to be sufficiently thick to produce the necessary absorption. A preferred minimum thickness of the backing body 21 is 0.5 mm. The preferred maximum thickness depends on practical considerations such as the methods of producing the backing portion. It is to be understood that the thicker the backing portion, the greater the cost of material. However a preferred thickness range is between 16 mm and 0.5 mm. A further preferred range is between 8 mm and 0.8 mm. These ranges are preferred because they are thick enough to absorb stress waves and support the transducers 2 so that the transducers 2 can react against the body 21 allowing sufficient wave energy into the structure 4, but are thin enough to be less prone to ‘setting’. A preferred thickness is 6 mm.

The device 1 may comprise an elongate strip of backing portion 20 material (for example one of the backing bodies 21 described above) upon which one or more, preferably a plurality, of transducers 2 are mounted.

When a plurality of transducers 2 are used in the device 1, they are preferably arranged into a pattern. This pattern may be a series of transducers sequentially arranged along a line. Such a configuration is useful for inspecting pipes. There may be one or more, preferably two or three, parallel lines of such transducers 2 extending along the long length of the strip. Preferably the transducers 2 are equally spaced apart on each line.

Preferably the transducers 2 are arranged such that when the device is secured to a pipe structure, the device may generate the T(0,1) mode in the pipe. Preferably the device 1 is configured to be able to generate only the T(0,1) mode in the pipe.

The transducers may be mounted upon the backing portion 20 in any suitable manner including using an adhesive or any suitably fixing mechanism or technique that allows the transducer 2 to be supported by a body 21 of the backing portion 20 and transduce stress waves into the structure 4.

In an alternative embodiment, the transducers 2 can be applied to an elastomeric material before the elastomeric material is cured. The curing of the elastomeric material adheres the transducers 2 to the elastomeric material. In a further alternative embodiment, an uncured elastomeric material can be poured over one or more of the transducers 2 to form at least a portion of (preferably all of) the backing layer.

Other methods of attaching the transducers 2 to the elastomeric material are known to the skilled person.

### Some Other Optional Portions of the Device

As stated above, an intermediate layer 18 may be disposed between the transducers 2 and the structure 4 being tested. Additionally or alternatively, one or more intermediate layers 18 may be disposed between the transducers 2 and the backing body 21. This layer is preferably a flexible layer or film. Preferably the body of the layer is non-electrically conductive, for example a polymer material.

As stated previously, the intermediate layers 18 in the examples of all the devices described herein preferably have thicknesses that do not efficiently transmit mechanical waves along the plane of the layer at the operating frequency of the device (i.e. the frequency of stress waves generated by the one or more transducers).

The intermediate layer 18 between the transducers 2 and the structure under test 4 needs to be sufficiently rigid so that the produced waves propagate to the structure being tested. Therefore, it is preferred that this intermediate layer is not formed from the same material as the backing body 21 that absorbs the stress waves This intermediate layer 18 is therefore preferably not an elastomeric material.

It is preferred that the material is flexible at room temperature. An example of a suitable material for this layer 18 is a polyimide such as Kapton™. In principle, other materials may be used including polyester (PET), polyimide (PI), polyethylene napthalate (PEN), Polyetherimide (PEI), fluropolymers (FEP) and copolymers.

The intermediate layer 18 may have a thickness between 25-200 μm, more preferably between 50-150 μm, and yet more preferably between 75-125 μm. At these thicknesses, the intermediate layer 18 does not efficiently transmit stress waves along the plane of the layer generated below 500 kHz. Furthermore, such thicknesses allow the intermediate layer 18 to be flexible so that the layer 18 can bend easily without breaking. Such flexibility allows the layer 18, hence device 1, to bend around or otherwise follow the shape of the structure under test 4.

The intermediate layer may be 100 μm thick. A thickness of 100 μm provides a thickness that is less prone to damage during transport and installation. The intermediate layer 18 is preferably sufficiently thick to prevent an electrical connection between the transducer 2 and the structure 4 being tested.

The intermediate layer 18 may be affixed to the transducers 2 using any suitable means, including but not limited to an adhesive such as a silver loaded epoxy adhesive.

The intermediate layer 18 may comprise one or more electrical tracks configured to electrically contact and provide one or more electrical signals to one or more of the transducers 2. This intermediate layer 18 may be a PCB. The electrical tracks may be comprised of any electrically conducting material, for example a metal or metal composite. The metal tracks may be copper. The tracks may be electrodeposited upon the layer 18 or are formed by rolling and annealing. The intermediate layer 18 may be arranged to be an electrically insulating layer between the transducers and the structure so that unwanted fluctuating residual currents in the structure do not affect the intended driving signals applied to the transducers 2.

### Securing Device

FIG. 6a shows an example of a securing device 38 for securing an inspection device, such as a mechanical wave generator to a structure 4. The securing device 38 comprises a rigid outer body 40 and an inner body 42 for contacting an inspection device. The inner body 42 comprises at least one of the materials as described above for the backing body 21 that absorbs mechanical stress waves. The outer body 40 may be comprised of any suitable rigid material that can be used to fixedly secure an inspection device to a structure 4, for example a hard plastic or a metal such as steel. The rigid material of the outer body 40 preferably at least partially surrounds the inner body 42.

In FIG. 6a, the securing device 38 is configured to secure an inspection device to a pipe 4. FIG. 6b shows the securing device 38 of FIG. 6a securing the inspection device to the pipe 4. The securing device 38 may comprise any suitable mechanisms for release-ably securing the inspection device to the structure 4 including, hinges and latches. For example the securing device 38 may take the form of a worm drive clamp.

The inspection device that the securing device 38 may secure to the structure 4 may in principle be any inspection device, including, but not limited to any device 1 as described herein. In one example, as shown in FIGS. 6a and 6b, the inspection device comprises a flexible intermediate layer 18 upon which a plurality of transducers 2 are mounted. The transducers 2 may be mounted in any way, including those arrangements described herein. The inspection device may comprise one or more electrical contacts (not shown in FIG. 6a/6b) as described herein. The intermediate layer 18 preferably, in use, resides between the structure 4 and the transducers 2. The intermediate layer 18 may be a PCB layer as described above. The securing device 38 and the inspection device may form an inspection system.

Embodiments of the present invention have been described with particular reference to the examples illustrated. However, it will be appreciated that variations and modifications may be made to the examples described within the scope of the present invention.

What is claimed is:

1.-37. (canceled)

38. A device for being secured to a structure, the device comprising:
A) a first portion comprising an element configured to impart mechanical waves to the structure upon application of a voltage, and,
B) a second portion supporting the element and comprising a body; wherein the first and second portions are configured such that:
the element reacts against the second portion to generate mechanical waves at least partially within the structure;
the body attenuates mechanical waves propagating from the first portion and away from the structure,
wherein the second portion is flexible and/or the body comprises elastomeric material.

39. A device as claimed in claim 38 configured to be secured to the structure by a securing device.

40. A device as claimed in claim 39 wherein the second portion is configured to electrically isolate the element from the securing device.

41. A device as claimed in claim 38 wherein the body has a Mooney viscosity of at least 50.

42. A device as claimed in claim 38 wherein the body has a Shore A hardness of 50 or higher.

43. A device as claimed in claim 38 wherein the element is a piezoelectric transducer.

44. A device as claimed in claim 38 wherein the element configured to impart mechanical waves comprises a shear polarised piezoelectric transducer.

45. A device as claimed in claim 38 wherein the device is configured to be able to detect and generate mechanical waves in the structure.

46. A device as claimed in claim 38 wherein the second portion is in contact with the element.

47. A device as claimed in claim 38 comprising one or more layers configured to provide electrical contact to the element and wherein the device is configured such that the at least one of the said layers is interposed between the element and the structure.

48. A device as claimed in claim 47 wherein any one or more of the said layers comprises a flexible PCB.

49. A device as claimed in claim 38, additionally comprising a securing device.

50. A device as claimed in claim 38, wherein the device is an inspection device for testing the structure for abnormalities and wherein the structure is a pipe.

51. A securing device for securing a mechanical wave generator to a structure, the mechanical wave generator arranged when secured to the structure to generate mechanical waves at least partially within the structure, the securing device comprising:
A) a first portion comprising a first material;
B) a second portion comprising a second material different from the first material and configured to attenuate mechanical waves propagating away from the structure towards the first portion, wherein the second material comprises an elastomeric material.

52. A securing device as claimed in claim 51 wherein the first material comprises a rigid material at least partially surrounding the second portion.

53. A securing device as claimed in claim 51 wherein the second material has a Mooney viscosity of at least 50 and/or a Shore A hardness of 51 or higher.

54. A device for being secured to a structure, the device comprising:
A) a first portion comprising an element configured to impart mechanical waves to the structure upon application of a voltage; and,
B) a second portion comprising a flexible layer configured to wrap the device at least partially around the structure.

55. A device as claimed in claim 54 comprising a plurality of the said elements arranged in a pattern along the second portion.

56. A device as claimed in claim 54 configured as a sheet.

57. A device as claimed in claim 56 wherein the sheet is an elongate strip having separate first and second terminating portions at the elongate ends of the strip.
